(19) United States
(12) Patent Application Publication
(10) Pub. No.: US 2013/0265333 A1
(43) Pub. Date: Oct. 10, 2013

(54) Augmented Reality Based on Imaged Object Characteristics

(71) Applicants: Lucas B. Ainsworth, Hillsboro, OR (US); James P. Melican, Hillsboro, OR (US); Tondra J. Schlieski, Beaverton, OR (US)

(72) Inventors: Lucas B. Ainsworth, Hillsboro, OR (US); James P. Melican, Hillsboro, OR (US); Tondra J. Schlieski, Beaverton, OR (US)

(21) Appl. No.: 13/993,220

(22) PCT Filed: Sep. 8, 2011
(86) PCT No.: PCT/US2011/050879

§ 371 Date: Jun. 11, 2013

(51) Int. Cl. G06T 19/00

(52) U.S. Cl. CPC G06T 19/006
USPC 345/633

(57) ABSTRACT

Augmented reality may be enabled by adding computer generated images to images of real world occurrences. The computer generated images may be inserted automatically based on a characteristic of an imaged object in said image.

### BACKGROUND

This relates generally to computers and, particularly, to augmented reality applications.

Augmented reality is the process of adding computer supplied content, including images, video, text, and other data as layers on computer displayed images of the real world. For example, when a mobile device, such as a cellular telephone, captures an image of a scene including different buildings, there are applications that can add information about the buildings, based on their global positioning system coordinate. For example, the address of the building and a link to a real estate listing for the building may be provided.

### BRIEF DESCRIPTION OF THE DRAWINGS

FIG. 1 is a depiction of an imaged scene with an overlaid marker in accordance with one embodiment of the present invention;

FIG. 2 is a depiction of an imaged scene with the imaged object having moved (relative to FIG. 1) relative to the overlaid marker in accordance with one embodiment of the present invention;

FIG. 3 corresponds to FIG. 2 with augmented reality in accordance with one embodiment of the present invention;

FIG. 4 is a depiction of an imaged screen using augmented reality in accordance with another embodiment of the present invention;

FIG. 5 is a flow chart for one embodiment of the present invention;

FIG. 6 is a flow chart for another embodiment of the present invention; and

FIG. 7 is a schematic depiction of one embodiment of the present invention.

### DETAILED DESCRIPTION

In some embodiments, augmented reality may guide human capture and playback of specific collections of digital media. These embodiments may leverage a combination of physical geometry of the space, human behavior, and programmed activities in order to create new and novel experiences. Embodiments may be applicable in gaming, community action, education, and photography, as examples.

In accordance with some embodiments of the present invention, based on a characteristic of an imaged object, augmented reality may be selectively applied to an image scene. For example, based on a characteristic of the image scene, such as the location of an object within the scene, recognition of the object, or recognition of a particular movement of the object, an augmented reality audio/visual object may be added to the scene. In this way, a computer supplied object may be overlaid on a real world image to augment the depiction.

In another embodiment of the present invention, a computer may place one or more markers on an imaged scene. Then the person capturing the image of the scene may encourage a person in the scene to interact with those markers, knowing that augmented reality will be applied based on the location of the markers.

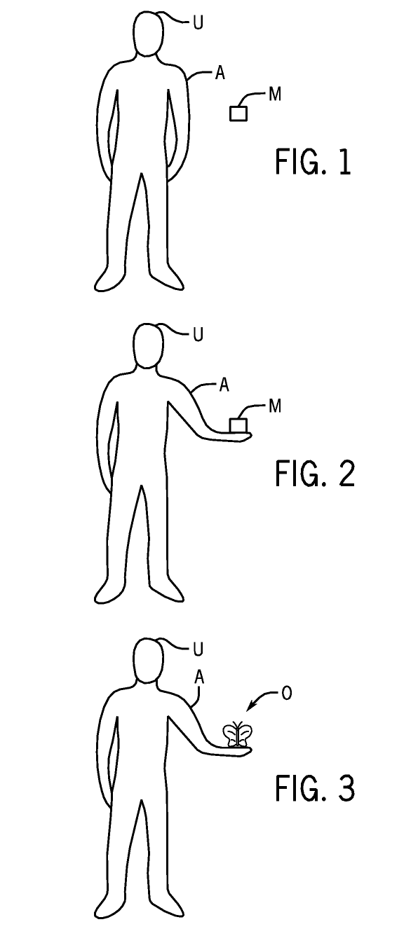

Referring to FIG. 1, an image object U, in this case a person, has an image arm A. The marker M is overlaid on the image by computer. The overlaying of the marker may be done by applying an additional layer onto the image, which layer may be largely transparent so that the underlying image may be seen. The marker M may be a guide to indicate to the person capturing the image that an augmented reality object may be overlaid on the ultimate image at that location. The image object U may be a still or moving image.

The image may be captured by any device with still or moving image capture capabilities, including a camera, a video camera, a cellular telephone, a mobile Internet device, a television, or a laptop computer, to mention a few examples.

Referring next to FIG. 2, the person capturing the image may encourage the user to extend the user's arm so his or her arm image A interacts with the overlaid marker M. The person capturing the image may encourage the arm movement, knowing that the marker M (that only the person capturing the image sees in this embodiment) marks the position where an overlaid augmented reality image will be inserted.

This insertion of an augmented reality image is shown in FIG. 3, where the image of a butterfly O is overlaid ultimately at the position of the marker M. In this embodiment, the marker M is overlaid on the image as it is being captured. In other words, the marker M is applied to the image being captured in real time. Then it appears as if the butterfly magically landed on the user's hand.

In accordance with another embodiment of the present invention, a computer may recognize a characteristic of an imaged object using digital image based pattern recognition or image analysis. The characteristic may be, for example, shape, color, orientation, a gestural movement, or speed, to mention a few examples. Digital image based pattern recognition or analysis identifies the characteristic by analyzing the content of the digital image, in contrast to simply comparing the image to other known images of the exact same object to identify an unknown image. In one embodiment, the digital image based pattern recognition or analysis identifies a human form. A human form is any part of a human being, including the entire body, the face, or any appendage, as examples.

For example, the object itself may be recognized using digital image based pattern recognition or analysis to determine what the object is. Recognition of a predefined characteristic may be used to initiate the generation of augmented reality by overlaying another audio/visual object on the image scene.

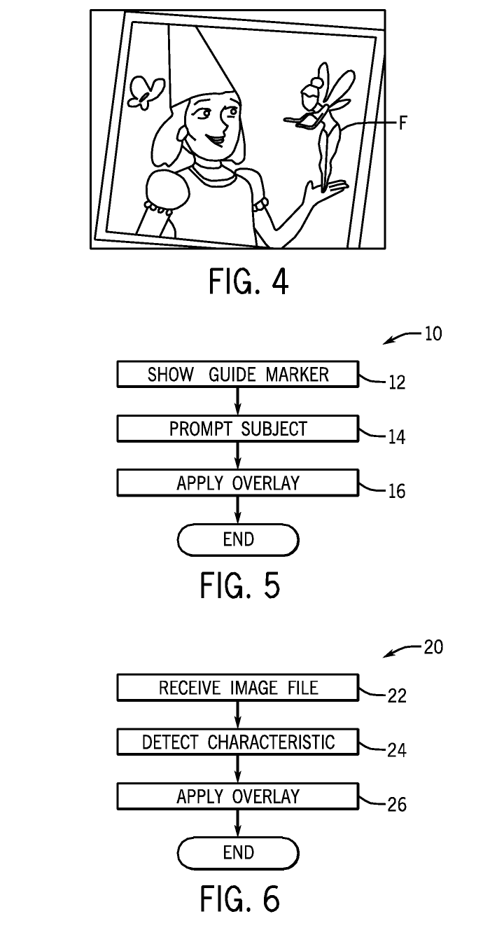

Thus, in the case of FIG. 4, a captured image of a girl wearing a magic cap is depicted. A computer system may detect the image of the cap and, based on that detection (using pattern recognition, for example), may automatically display an image of a fairy F on the hand of the depicted image of the girl.

As another example, the computer, again using video image analysis, can recognize the girl's outstretched arm. Recognition of the outstretched arm (effectively, a gestural command) may be the trigger to generate the fairy image F. As still another example, the computer may recognize a movement to outstretch the left arm and, based on this recognized movement, may generate the fairy image F.

In each case, a characteristic of the image of the object, such as its shape or gestural motion, is used to automatically overlay an audio/visual image object at a desired location within the display.

In other embodiments, a given characteristic of an image object may be used to generate audio. For example, when the imaged object is recognized as a conductor directing an orchestra, the sound of an orchestra may be automatically added to the audio/visual media.

As an additional example, an image scene from a fixed camera may be analyzed to recognize a vehicle moving within an intersection at the time when a red light is visible. The computer may automatically overlay the word “violation” on the image to assist an officer in implementing a red light camera traffic enforcement system. As another traffic application, a fixed camera on a roadside may image cars going by. The captured image of a car going faster than the speed limit may be overlaid with the word “violation.”

As still another example, a security camera may detect a person at an unauthorized location and may overlay the object with the word “violation” or may, by speech synthesis, say the word “intruder.”

In many cases, a characteristic of the imaged object, (other than its global positioning system (GPS) coordinates, which is not a characteristic of the imaged object) may be used to generate augmented reality. In some embodiments, global positioning system coordinates may also be used in addition to non-GPS based characteristics.

Augmented reality overlays may be provided in real time at the time of image capture or may be overlaid later using digital image based content recognition of the captured scene or series of frames. For example, an extended moving picture file may be analyzed to search for particularly shaped objects and, when those objects are found, augmented reality may be added to enhance the depiction.

Referring to FIG. 5, the sequence 10 may be used in an embodiment such as the one depicted in FIGS. 1-3. The sequence 10 may be implemented in software, hardware, and/or firmware. In software or firmware based embodiments, the sequence may be implemented by computer readable instructions stored on a non-transitory computer readable medium, such as a semiconductor, magnetic, or optical memory.

At block 12, guide markers are automatically overlaid on an imaged object as the depiction is being captured as a still or moving picture. In some embodiments, the overlaid marker or markers may be overlaid as a layer that overlays the imaged picture, the marker being non-transparent, but the rest of the overlay being transparent.

At block 14, the user capturing the images may be prompted to prompt the subject to move in a desired way to interact with the marker so that the desired effect may be achieved through the application of augmented reality.

Then, the augmented reality audio/visual object may be automatically applied over the existing scene, as depicted in block 16, in some embodiments. The application of augmented reality may be the result of a user input command in one embodiment. In another embodiment, it may occur after the marker has been displayed for a time period. In one embodiment, the marker and the object may be the same.

The sequence 20, shown in FIG. 6, may be used, for example, to implement embodiments such as the one depicted in FIG. 4. Again, the sequence 20 may be implemented in software, firmware, and/or hardware. In software and firmware embodiments, the sequence may be implemented by computer readable instructions stored on a non-transitory computer readable medium, such as a semiconductor, optical, or magnetic memory.

The sequence may begin by receiving an image file that may be composed of a still image or a series of frames of a moving image, as indicated in block 22. Then, a given characteristic of an imaged object is detected (block 24). As described above, a variety of image characteristics of the image itself, not the real world object (i.e., not its GPS coordinate), may be used to trigger the generation of augmented reality. Again, examples of such characteristics of the image include shape recognition, movement, speed, gestural commands, color, and position within the imaged scene relative to one or more other depicted objects.

For example, in a computer animation, two players may be driving race cars and when the system detects that the race cars come together, the system may generate a crash image or a crash sound, overlaid on the ongoing depiction. Such an embodiment may be described as augmented virtual reality, but since the race car image was generated in the real world, this is actually another example of augmented reality.

Finally, in block 26, the augmented reality overlay is overlaid over the existing captured or computer generated image.

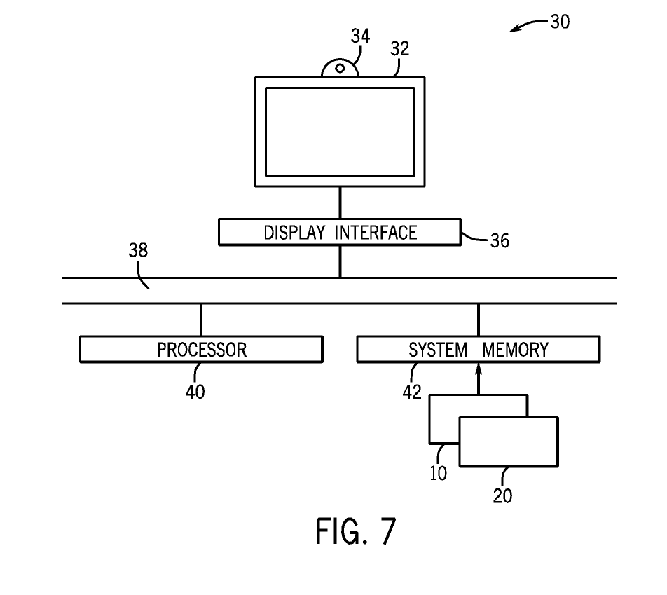

Referring to FIG. 7, in accordance with one embodiment, a computer 30 for implementing embodiments of the present invention may include a display screen 32 with an integrated video camera 34, in some embodiments. Of course, the video camera 34 may be separate from the computer system 30 and/or the display screen 32. The display screen 32 is coupled to a bus 38 by a display interface 36.

The bus 38 may be conventionally coupled to a processor 40 and a system memory 42. The processor may be any controller, including a central processing unit or a graphics processing unit. In some embodiments, the system memory 42 may store the computer readable instructions implementing the sequences 10 and/or 20, in the case where the sequences 10 and/or 20 are implemented by firmware or software.

The embedded augmented reality layer may have the following characteristics, in some embodiments:
the layer may be “free form”—i.e., it responds to real world real time events, not just to pre-programmed or pre-loaded events;
the layer may be transitory (visible during capture as a guide, but not transferred to the media output) or integrated (i.e., visible during capture and integrated into the media output);
the guidance provided by the layer may be context aware, and may reflect one or more of the following variables: location of the subject, the geometry of the space, the movement within the frame, the RBG image content of the frame, and/or other sensor data, like noise, heat, electrical charge, wireless signal; and/or
the augmented reality layer may interact with the human subject capturing media, to direct that capture toward a programmed objective.

An embodiment may leverage human behavior. A user at a theme park, waiting in line for an attraction, can play with or tell stories with characters from the theme park, and create a take-away “movie” of his or her experience:
user A launches the fairy story application and points an image capture device at user B;
user A sees characters on the screen, which respond to the movement and interaction of user B;
the interaction is captured (integrated with the augmented digital media) and can be played back on the capture device, displayed real time on a screen in line, or sent home as a movie;
user A (with the image capture device) can leverage his or her augmented reality application to direct the screen to other players within the space (i.e., by changing the focus of the camera, and user A can send the fairy to another person in line). The reactions of user C continue to inform the augmented reality behavior of the fairy.
   This embodiment also illustrates how visible real time playback can be used to influence capture, specifically:
the application in this situation is programmed to allow users to share their capture on the screens provided in line;
both the human subject (as determined by the view finder) and the animation (digital overlay) play real time on the screen. User A then “directs” a scene in which the fairies visit and interact with different people in line. The subject gestures and reactions (laughter, annoyance) are all recognized by the system, and the digital animation layer changes its behavior based on the subject's reaction.

The graphics processing techniques described herein may be implemented in various hardware architectures. For example, graphics functionality may be integrated within a chipset.

Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using digital image based image analysis to detect a characteristic of an imaged object displayed on a display screen; and
based on said characteristic, overlaying an audio or visual object on said display screen.

2. The method of claim 1 wherein using digital image based image analysis includes detecting a human form.

3. The method of claim 1 including analyzing an image in association with said human form.

4. The method of claim 1 including recognizing a characteristic that is a gestural command.

5. The method of claim 1 including recognizing a shape, color, orientation, or speed of the imaged object.

6. A method comprising:
overlying a marker on the display of an imaged scene; and
using the marker to augment reality.

7. The method of claim 6 wherein using includes applying a computer generated image to said display.

8. The method of claim 7 including using a marker that is the same as the image.

9. The method of claim 7 including replacing said marker with a computer generated image.

10. A non-transitory computer readable medium storing instructions to enable a processor-based device to:
use digital image based image analysis to identify a characteristic of an imaged object and, based on that characteristic, overlay an audio or visual object on the display screen.

11. The medium of claim 10 further storing instructions to use said digital image based image analysis to detect a human form.

12. The medium of claim 10 further storing instructions to analyze an image in association with the human form.

13. The medium of claim 10 further storing instructions to recognize a characteristic in the form of a gestural command.

14. The medium of claim 10 further storing instructions to recognize shape, color, orientation, or speed of an imaged object.

15. The medium of claim 10 further storing instructions to overlay an indicator on an uncaptured image and to use the indicator as a marker to position an augmented reality depiction.

16. The medium of claim 15 further storing instructions to use the marker to apply a computer generated image to the display at the position of the marker.

17. The medium of claim 16 further storing instructions to use the marker that is the same as the image.

18. The medium of claim 16 further storing instructions to replace the marker with a computer generated image.

19. An apparatus comprising:
an image capture device;
a processor coupled to said image capture device; and
said processor to overlay a marker on an image display and to use said marker for augmented reality.

20. The apparatus of claim 19, said processor to substitute the augmented reality image for said marker in a captured depiction.

21. The apparatus of claim 19, said processor to overlay said marker in a depiction of a scene in said image capture device before an image of the scene is captured.

22. The apparatus of claim 19 including a display screen coupled to said processor.

23. The apparatus of claim 22, said processor to use digital image based image analysis to identify a characteristic of an imaged object and, based on that characteristic, overlay an audio or visual object on the display.

24. The apparatus of claim 23, said processor to use said digital image based image analysis to detect a human form.

25. The apparatus of claim 24, said processor to analyze an image in association with the human form.

26. The apparatus of claim 24, said processor to recognize a characteristic in the form of a gestural command.
